(19) United States
(12) Patent Application Publication
(10) Pub. No.: US 2024/0014440 A1
(43) Pub. Date: Jan. 11, 2024

(54) GEL POLYMER ELECTROLYTE WITH SULFOLENE ADDITIVE

(71) Applicant: GM GLOBAL TECHNOLOGY OPERATIONS LLC, Detroit, MI (US)

(72) Inventors: Qili SU, Shanghai (CN); Zhe LI, Shanghai (CN); Haijing LIU, Shanghai (CN); Lidan XING, Guangzhou (CN); Lijiao QUAN, Guangzhou (CN)

(73) Assignee: GM GLOBAL TECHNOLOGY OPERATIONS LLC, Detroit, MI (US)

(21) Appl. No.: 17/900,048

(22) Filed: Aug. 31, 2022

(30) Foreign Application Priority Data
Jul. 5, 2022 (CN) 202210782683.5

(51) Int. Cl. H01M 10/0565

(52) U.S. Cl. CPC H01M 10/0565; H01M 10/0525

(57) ABSTRACT

The present disclosure a gel polymer electrolyte for an electrochemical cell that cycles lithium ions. The gel polymer electrolyte includes a polymer host, a liquid electrolyte, and greater than or equal to about 0.1 wt. % to less than or equal to about 10 wt. % of a sulfolene additive. In certain variations, the gel polymer electrolyte also includes greater than or equal to about 0.1 wt. % to less than or equal to about 5 wt. % of an ethylene carbonate additive. The ethylene carbonate additive may be selected from the group consisting of: vinyl ethylene carbonate (VEC), fluoroethylene carbonate (FEC), vinylene carbonate, and combinations thereof. In each instance, the lithium electrolyte may include a first lithium salt, a second lithium salt that is distinct from the first lithium salt, and a third lithium salt that is distinct from the first lithium salt and the second lithium salt.

### CROSS-REFERENCE TO RELATED APPLICATIONS

This application claims the benefit of Chinese Patent Application No. 202210782683.5 filed on Jul. 5, 2022. The entire disclosure of the application referenced above is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In instances of solid-state batteries, which include a solid-state electrolyte layer disposed between the solid-state electrodes, the solid-state electrolyte physically separates the solid-state electrodes so that a distinct separator is not required.

Semi-solid batteries have advantages over batteries that include a separator and a liquid electrolyte. These advantages can include a longer shelf life with lower self-discharge, simpler thermal management, a reduced need for packaging, and the ability to operate within a wider temperature window. For example, semi-solid electrolytes are generally non-volatile and non-flammable, so as to allow cells to be cycled under harsher conditions without experiencing diminished potential or thermal runaway, which can potentially occur with the use of liquid electrolyte. However, semi-solid or gel electrolytes often do not promote formation of uniform solid-state electrolyte interphase (SEI) layers that are able to limit electrolyte decomposition and reversible lithium insertion/extraction of anode materials. Accordingly, it would be desirable to develop high-performance semi-materials and battery designs, as well as methods of making and using the same.

### SUMMARY

This section provides a general summary of the disclosure, and is not a comprehensive disclosure of its full scope or all of its features.

The present disclosure relates to an electrochemical cell that cycles lithium ions, and more particularly, to electrochemical cells including gel polymer electrolytes, and methods of making and using the same.

In various aspects, the present disclosure a gel polymer electrolyte for an electrochemical cell that cycles lithium ions. The gel polymer electrolyte may include a polymer host, a liquid electrolyte, and greater than or equal to about 0.1 wt. % to less than or equal to about 10 wt. % of a sulfolene additive.

In one aspect, the gel polymer electrolyte may further include greater than or equal to about 0.1 wt. % to less than or equal to about 5 wt. % of an ethylene carbonate additive. The ethylene carbonate additive may be selected from the group consisting of: vinyl ethylene carbonate (VEC), fluoroethylene carbonate (FEC), vinylene carbonate, and combinations thereof.

In one aspect, the sulfolene additive may comprise 3-sulfolene (3-SF) or may be represented by one of the following structures:

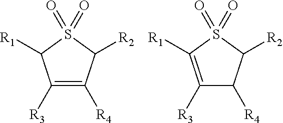

where R₁, R₂, R₃, and R₄ are independently selected from hydrogen, linear or branched alkyl groups, linear or branched alkene groups, linear or branched alkoxyl groups, linear or branched ether groups, phenyl groups, mono-substituted phenyl groups having linear or branched alkyl groups, di-substituted phenyl groups having linear or branched alkyl groups, tri-substituted phenyl groups having linear or branched alkyl groups, nitro groups, cyanogen groups, and halogen groups, or a combination thereof.

In one aspect, the gel polymer electrolyte may include greater than 0 wt. % to less than or equal to about 40 wt. % of the polymer host. The polymer host may be selected from the group consisting of: poly(acrylic acid) (PAA), polyvinylidene difluoride (PVDF), poly(vinyl alcohol) (PVA), polyethylene oxide (PEO), polyvinylidene fluoride-hexafluoropropylene (PVDF-HFP), polymethyl methacrylate (PMMA), carboxymethyl cellulose (CMC), polyacrylonitrile (PAN), polyvinylpyrrolidone (PVP), and combinations thereof.

In one aspect, the liquid electrolyte may have a lithium salt concentration greater than or equal to about 1.2 M.

In one aspect, the liquid electrolyte may include a first lithium salt and a second lithium salt. The first lithium salt may include a lithium cation (Li⁺) and an anion selected from the group consisting of: bis(trifluoromethanesulfonyl)imide (TFSI), trifluoromethanesulfonate (triflate), bis(fluorosulfonyl)imide cyclo-difluoromethane-1,1-bis(sulfonyl)imide (DMSI), bis(perfloroethanesulfonyl)imide (BETI), cyclo-hexafluoropropane-1,1-bis(sulfonyl)imide (HPSI), and combinations thereof. The second lithium salt may include a lithium cation (Li⁺) and an anion selected from the group consisting of: tetrafluoroborate, bis(oxalate)boarate (BOB), tetracyanoboarate (bison), difluoro(oxalato)borate (DFOB), bis(fluoromalonato)borate (BFMB), and combinations thereof.

In one aspect, a concentration of the first lithium salt may be greater than or equal to about 0.6 M to less than or equal to about 2.0 M, and a concentration of the second lithium salt may be greater than or equal to about 0.6 M to less than or equal to about 2.0 M.

In one aspect, the liquid electrolyte may further include a third lithium. The third lithium salt is distinct from the second lithium salt and may include a lithium cation (Li⁺) and an anion selected from the group consisting of: bis(oxalate)boarate (BOB), tetrafluoroborate, tetracyanoboarate (bison), difluoro(oxalato)boarate (DFOB), bis(floromalonato)borate (BFMB), and combinations thereof.

In one aspect, a concentration of the third lithium salt may be greater than or equal to about 0.05 M to less than or equal to about 1.0 M.

In various aspects, the present disclosure provides a semi-solid state electrochemical cell. The semi-solid-state electrochemical cell may include a first electrode, a second electrode, and a separating layer that physically separates the first electrode and the second electrode. The first electrode may include a positive electroactive material. The second electrode may include a negative electroactive material. The separating layer may include a gel polymer electrolyte that includes a polymer host, a liquid electrolyte, greater than or equal to about 0.1 wt. % to less than or equal to about 10 wt. % of a sulfolene additive, and greater than or equal to about 0.1 wt. % to less than or equal to about 5 wt. % of an ethylene carbonate additive. The ethylene carbonate additive may be selected from the group consisting of: vinyl ethylene carbonate (VEC), fluoroethylene carbonate (FEC), vinylene carbonate, and combinations thereof.

In one aspect, the semi-solid state electrochemical cell may include a solid-state electrolyte interphase (SEI) layer at an interface between the second electrode and the separating layer. The solid-state electrolyte interphase (SEI) layer may have an average thickness greater than or equal to about 10 nm to less than or equal to about 50 nm. The solid-state electrolyte interphase (SEI) layer may cover greater than or equal to about 95% of a surface of the second electrode.

In one aspect, the sulfolene additive may include 3-sulfolene (3-SF) or may be represented by one of the following structures:

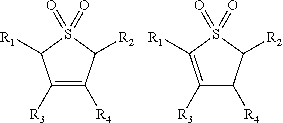

where R₁, R₂, R₃, and R₄ are independently selected from hydrogen, linear or branched alkyl groups, linear or branched alkene groups, linear or branched alkoxyl groups, linear or branched ether groups, phenyl groups, mono-substituted phenyl groups having linear or branched alkyl groups, di-substituted phenyl groups having linear or branched alkyl groups, tri-substituted phenyl groups having linear or branched alkyl groups, nitro groups, cyanogen groups, and halogen groups, or a combination thereof.

In one aspect, the liquid electrolyte may include a first lithium salt, a second lithium salt, and a third lithium salt. The second lithium salt may be distinct from the first lithium salt, and the third lithium salt may be distinct from the first and second lithium salts. The first lithium salt may include a lithium cation (Li⁺) and an anion selected from the group consisting of: bis(trifluoromethanesulfonyl)imide (TFSI), trifluoromethanesulfonate (triflate), bis(fluorosulfonyl)imide (FR), cyclo-difluoromethane-1,1-bis(sulfonyl)imide (DMSI), bis(perfloroethanesulfonyl)imide (BETI), cyclo-hexafluoropropane-1,1-bis(sulfonyl)imide (HP SI), and combinations thereof. The second lithium salt may include a lithium cation (Li⁺) and an anion selected from the group consisting of: tetrafluoroborate, bis(oxalate)boarate (BOB), tetracyanoboarate (bison), difluoro(oxalato)borate (DFOB), bis(fluoromalonato)borate (BFMB), and combinations thereof. The third lithium salt may include a lithium cation (Li⁺) and an anion selected from the group consisting of: bis(oxalate)boarate (BOB), tetrafluoroborate, tetracyanoboarate (bison), difluoro(oxalato)boarate (DFOB), bis(floromalonato)borate (BFMB), and combinations thereof.

In one aspect, a concentration of the first lithium salt may be greater than or equal to about 0.6 M to less than or equal to about 2.0 M, a concentration of the second lithium salt may be greater than or equal to about 0.6 M to less than or equal to about 2.0 M, and a concentration of the third lithium salt may be greater than or equal to about 0.05 M to less than or equal to about 1.0 M.

In one aspect, the gel polymer electrolyte may be a first gel polymer electrolyte, and the first electrode may further include a second gel polymer electrolyte, and the second electrode may further include a third gel polymer electrolyte.

In one aspect, the first electrode may further include a first plurality of solid-state electrolyte particles, and the second electrode may further include a second plurality of solid-state electrolyte particles.

In one aspect, the separating layer may further include a plurality of solid-state electrolyte particles.

In one aspect, the separating layer may further include a microporous polymeric separator having a porosity greater than or equal to about 5 vol. % to less than or equal to about 100 vol. %.

In various aspects, the present disclosure provides a gel polymer electrolyte for an electrochemical cell that cycles lithium ions. The gel polymer electrolyte may include greater than or equal to about 1 wt. % to less than or equal to about 40 wt. % of a polymer host, a liquid electrolyte, greater than or equal to about 0.1 wt. % to less than or equal to about 10 wt. % of a sulfolene additive, and greater than or equal to about 0.1 wt. % to less than or equal to about 5 wt. % of an ethylene carbonate additive. The ethylene carbon additive may be selected from the group consisting of: vinyl ethylene carbonate (VEC), fluoroethylene carbonate (FEC), vinylene carbonate, and combinations thereof. The liquid electrolyte may include a first lithium salt, a second lithium salt, and a third lithium salt. The second lithium salt may be different from the first lithium salt, and the third lithium salt may be different from the second lithium salt and the first lithium salt. The first lithium salt may include a lithium cation (Li⁺) and an anion selected from the group consisting of: bis(trifluoromethanesulfonyl)imide (TFSI), trifluoromethanesulfonate (triflate), bis(fluorosulfonyl)imide (FSI), cyclo-difluoromethane-1,1-bis(sulfonyl)imide (DMSI), bis(perfloroethanesulfonyl)imide (BETI), cyclo-hexafluoropropane-1,1-bis(sulfonyl)imide (HPSI), and combinations thereof. The second lithium salt may include a lithium cation (Li⁺) and an anion selected from the group consisting of: tetrafluoroborate, bis(oxalate)boarate (BOB), tetracyanoboarate (bison), difluoro(oxalato)borate (DFOB), bis(fluoromalonato)borate (BFMB), and combinations thereof. The third lithium salt may include a lithium cation (Li⁺) and an anion selected from the group consisting of: bis(oxalate)boarate (BOB), tetrafluoroborate, tetracyanoboarate (bison), difluoro(oxalato)boarate (DFOB), bis(floromalonato)borate (BFMB), and combinations thereof.

In one aspect, sulfolene additive may include 3-sulfolene (3-SF) or may be represented by one of the following structures:

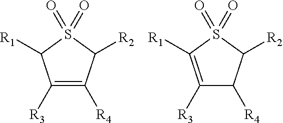

where R₁, R₂, R₃, and R₄ are independently selected from linear or branched alkyl groups, linear or branched alkene groups, linear or branched alkoxyl groups, linear or branched ether groups, phenyl groups, mono-substituted phenyl groups having linear or branched alkyl groups, di-substituted phenyl groups having linear or branched alkyl groups, tri-substituted phenyl groups having linear or branched alkyl groups, nitro groups, cyanogen groups, and halogen groups, or a combination thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical cell including a gel polymer electrolyte in accordance with various aspects of the present disclosure;

FIG. 2 is an illustration of another example electrochemical cell including a gel polymer electrolyte in accordance with various aspects of the present disclosure;

FIG. 3A is a microscopic image of an electrode-separator interface for an example electrochemical cell including a gel polymer electrode having a sulfolene additives and another additive in accordance with various aspects of the present disclosure, where the scale is 100 nm;

FIG. 3B is another microscopic image of the electrode-separator interface for the example electrochemical cell including the gel polymer electrode having a sulfolene additives and another additive in accordance with various aspects of the present disclosure, where the scale is 50 nm;

FIG. 4A is a microscopic image of an electrode-separator interface for a first comparative electrochemical cell including a gel polymer electrode having another additive, where the scale is 100 nm;

FIG. 4B is another microscopic image of the electrode-separator interface for the first comparative electrochemical cell including the gel polymer electrode having another additive, where the scale is 50 nm;

FIG. 5A is a microscopic image of an electrode-separator interface for a second comparative electrochemical cell including a gel polymer electrode that has no additives, where the scale is 100 nm;

FIG. 5B is another microscopic image of the electrode-separator interface for the second comparative electrochemical cell including the gel polymer electrode that has no additives, where the scope is 50 nm;

FIG. 6 is a graphical illustration demonstrating the rate capability of an example electrochemical cell including the gel polymer electrode having a sulfolene additives and another additive in accordance with various aspects of the present disclosure;

FIG. 7 is a graphical illustration demonstrating the low-temperature discharge performance of an example electrochemical cell including the gel polymer electrode having a sulfolene additives and another additive in accordance with various aspects of the present disclosure;

FIG. 8 is a graphical illustration demonstrating high-temperature cycling performance of an example electrochemical cell including the gel polymer electrode having a sulfolene additives and another additive in accordance with various aspects of the present disclosure;

FIG. 9 is a graphical illustration demonstrating the initial cycle Columbic Efficiency of an example electrochemical cell including the gel polymer electrode having a sulfolene additives and another additive in accordance with various aspects of the present disclosure;

FIG. 10 is a graphical illustration demonstrating the direct current resistance (DCR) of an example electrochemical cell including the gel polymer electrode having a sulfolene additives and another additive in accordance with various aspects of the present disclosure; and

FIG. 11 is a graphical illustration demonstrating the fresh cold-cranking capabilities of an example electrochemical cell including the gel polymer electrode having a sulfolene additives and another additive in accordance with various aspects of the present disclosure.

Corresponding reference numerals indicate corresponding parts throughout the several views of the drawings.

### DETAILED DESCRIPTION

Example embodiments are provided so that this disclosure will be

thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical batteries including gel polymer electrolytes having sulfolene additives, and methods of making and using the same. In various aspects, the batteries may have a bipolar stacking design comprising a plurality of bipolar electrodes where a first mixture of electroactive material particles (and optional solid-state electrolyte particles and/or gel polymer electrolyte) is disposed on a first side of a current collector, and a second mixture of electroactive material particles (and optional solid-state electrolyte particles and/or gel polymer electrolyte) is disposed on a second side of a current collector that is parallel with the first side. The first mixture may include, as the electroactive material particles, cathode material particles. The second mixture may include, as the electroactive material particles, anode material particles. The solid-state electrolyte particles in each instance may be the same or different. The gel polymer electrolytes in each instance may be the same or different.

In other variations, the batteries may have a monopolar stacking design comprising a plurality of monopolar electrodes where a first mixture of electroactive material particles (and optional solid-state electrolyte particles and/or gel polymer electrolyte) is disposed on both a first side and a second side of a first current collector, wherein the first and second sides of the first current collector are substantially parallel, and a second mixture of electroactive material particles (and optional solid-state electrolyte particles and/or gel polymer electrolyte) is disposed on both a first side and a second side of a second current collector, where the first and second sides of the second current collector are substantially parallel. The first mixture may include, as the electroactive material particles, cathode material particles. The second mixture may include, as electroactive material particles, anode material particles. The solid-state electrolyte particles in each instance may be the same or different. The gel polymer electrolytes in each instance may be the same or different. In certain variations, the batteries may include a mixture of combination of bipolar and monopolar stacking designs.

Such batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

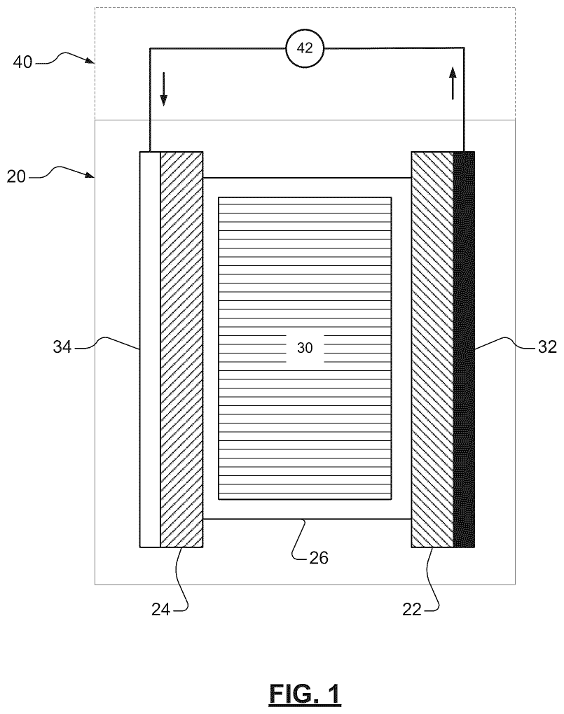

An exemplary and schematic illustration of an example electrochemical cell (also referred to as a battery) 20 is shown in FIG. 1. The battery 20 includes a negative electrode 22 (e.g., anode), a positive electrode 24 (e.g., cathode), and a separator 26 that occupies a space defined between the two or more electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In each variation, the electrolyte 30 may be a semi-solid or gel polymer electrolyte. For example, the separator 26 may include a first gel polymer electrolyte, the negative electrode 22 may include a second gel polymer electrolyte, and the positive electrode 24 may include a third gel polymer electrolyte. The second gel polymer electrolyte may be the same as or different from the first gel polymer electrolyte, and the third gel polymer electrolyte may be the same as or different from the second gel polymer electrolyte.

A first current collector 32 may be positioned at or near the negative electrode 22. The first current collector 32 may be a metal foil, metal grid or screen, or expanded metal comprising copper or any other appropriate electrically conductive material known to those of skill in the art. A second current collector 34 may be positioned at or near the positive electrode 24. The second current collector 34 may be a metal foil, metal grid or screen, or expanded metal comprising aluminum or any other appropriate electrically conductive material known to those of skill in the art. The first current collector 32 and the second current collector 34 may be the same or different. The first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

Although not illustrated, the skilled artisan will recognize that in certain variations, the first current collector 32 may be a first bipolar current collector and/or the second current collector 34 may be a second bipolar current collector. For example, the first bipolar current collector 34 and/or the second bipolar current collector 34 may be cladded foils, for example, where one side (e.g., the first side or the second side) of the current collector 32, 34 includes one metal (e.g., first metal) and another side (e.g., the other side of the first side or the second side) of the current collector 32 includes another metal (e.g., second metal). In certain variations, the cladded foils may include, for example only, aluminum-copper (Al—Cu), nickel-copper (Ni—Cu), stainless steel-copper (SS-Cu), aluminum-nickel (Al—Ni), aluminum-stainless steel (Al-SS), and nickel-stainless steel (Ni-SS). In certain variations, the first bipolar current collector 32 and/or second bipolar current collectors 34 may be pre-coated including, for example, graphene or carbon-coated aluminum current collectors.

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the separator 26 towards the positive electrode 24. The electrons flow through the external circuit 40 and the lithium ions migrate across the separator 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the separator 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the separator 26.

In many configurations, each of the first current collector 32, the negative electrode 22, the separator 26, the positive electrode 24, and the second current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, as noted above, the positive electrode 24, the negative electrode 22, and the separator 26 may each include an electrolyte solution or system 30 inside their pores, capable of conducting lithium ions between the negative electrode 22 and the positive electrode 24. In certain variations, the electrolyte 30 may be a semi-solid or gel polymer electrolyte including, for example, a polymer host and a liquid electrolyte, as well as a sulfolene additive. For example, the electrolyte 30 may include greater than or equal to about 0 wt. % to less than or equal to about 40 wt. %, and in certain aspects, optionally about 5 wt. %, of the polymer host; and greater than or equal to about 0.1 wt. % to less than or equal to about 10 wt. %, optionally greater than or equal to about 0.1 wt. % to less than or equal to about 5 wt. %, and in certain aspects, optionally about 1 wt. %, of the sulfolene additive. In certain variations, the polymer host may be selected from the group consisting of: poly(acrylic acid) (PAA), polyvinylidene difluoride (PVDF), poly(vinyl alcohol) (PVA), polyethylene oxide (PEO), polyvinylidene fluoride-hexafluoropropylene (PVDF-HFP), polymethyl methacrylate (PMMA), carboxymethyl cellulose (CMC), polyacrylonitrile (PAN), polyvinylpyrrolidone (PVP), and combinations thereof.

The liquid electrolyte includes a lithium salt and a solvent (also referred to as a plasticizer or a plasticizer solvent). The lithium salt includes a lithium cation (Li⁺) and an anion selected from the group consisting of: hexafluoroarsenate, hexafluorophosphate, bis(fluorosulfonyl)imide (FSI), perchlorate, tetrafluoroborate, cyclo-difluoromethane-1,1-bis(sulfonyl)imide (DMSI), bis(trifluoromethanesulfonyl)imide (TFSI), bis(perfloroethanesulfonyl)imide (BETI), bis(oxalate)boarate (BOB), difluoro(oxalato)borate (DFOB), bis(fluoromalonato)borate (BFMB), trifluoromethanesulfonate (triflate), tetracyanoboarate (bison), cyclo-hexafluoropropane-1,1-bis(sulfonyl)imide (HPSI), and combinations thereof.

For example, in certain variations, the lithium salt may include a first lithium salt and a second lithium salt. The liquid electrolyte may a concentration of the first lithium salt that is greater than or equal to about 0.6 M to less than or equal to about 2.0 M, and in certain aspects, optionally about 0.8 M, and a concentration of the second lithium salt that is greater than or equal to about 0.6 M to less than or equal to about 2.0 M, and in certain aspects, optionally about 0.8 M, such that the liquid electrolyte has a total salt concentration that is greater than or equal to about 1.2 M.

The first lithium salt may include a lithium cation (Li⁺) and an anion selected from the group consisting of: bis(trifluoromethanesulfonyl)imide (TFSI), trifluoromethanesulfonate (triflate), bis(fluorosulfonyl)imide (FSI), cyclo-difluoromethane-1,1-bis(sulfonyl)imide (DMSI), bis(perfloroethanesulfonyl)imide (BETI), cyclo-hexafluoropropane-1,1-bis(sulfonyl)imide (HPSI), and combinations thereof. The second lithium salt may include a lithium cation (Li⁺) and an anion selected from the group consisting of: tetrafluoroborate, bis(oxalate)boarate (BOB), tetracyanoboarate (bison), difluoro(oxalato)borate (DFOB), bis(fluoromalonato)borate (BFMB), and combinations thereof.

In still further variations, the lithium salt may include a first lithium salt, a second lithium salt distinct from the first salt, and a third lithium salt distinct from the first and second salts. The liquid electrolyte may a concentration of the first lithium salt that is greater than or equal to about 0.6 M to less than or equal to about 2.0 M, and in certain aspects, optionally about 0.8 M; a concentration of the second lithium salt that is greater than or equal to about 0.6 M to less than or equal to about 2.0 M, and in certain aspects, optionally about 0.8 M; and a concentration of the third lithium salt that is greater than or equal to about 0.05 M to less than or equal to about 1.0 M, and in certain aspects, optionally about 0.1 M, such that the liquid electrolyte has a total salt concentration that is greater than or equal to about 1.25 M.

The first lithium salt may include a lithium cation (Li⁺) and an anion selected from the group consisting of: bis(trifluoromethanesulfonyl)imide (TFSI), trifluoromethanesulfonate (triflate), bis(fluorosulfonyl)imide (FSI), cyclo-difluoromethane-1,1-bis(sulfonyl)imide (DMSI), bis(perfloroethanesulfonyl)imide (BETI), cyclo-hexafluoropropane-1,1-bis(sulfonyl)imide (HP SI), and combinations thereof. The second lithium salt may include a lithium cation (Li⁺) and an anion selected from the group consisting of: tetrafluoroborate, bis(oxalate)boarate (BOB), tetracyanoboarate (bison), difluoro(oxalato)borate (DFOB), bis(fluoromalonato)borate (BFMB), and combinations thereof. The third lithium salt may include a lithium cation (Li⁺) and an anion selected from the group consisting of: bis(oxalate)boarate (BOB), tetrafluoroborate, tetracyanoboarate (bison), difluoro(oxalato)boarate (DFOB), bis(floromalonato)borate (BFMB), and combinations thereof. For example, in certain variations, the lithium salt may include lithium bis(trifluoromethanesulfonyl)imide (LiTFSI), lithium tetrafluoroborate (LiBF₄), and lithium bis(oxalato)borate (LiB(C₂O₄)₂) (LiBOB), respectively.

The solvent dissolves the lithium salt to enable good lithium ion conductivity, while also exhibiting a low vapor pressure (e.g., less than about 10 mmHg at 25° C.) to match the cell fabrication process. In various aspects, the solvent includes, for example, carbonate solvents (such as, ethylene carbonate (EC), propylene carbonate (PC), glycerol carbonate, vinylene carbonate, fluoroethylene carbonate, 1,2-butylene carbonate, and the like), lactones (such as, γ-butyrolactone (GBL), δ-valerolactone, and the like), nitriles (such as, succinonitrile, glutaronitrile, adiponitrile, and the like), sulfones (such as, tetramethylene sulfone, ethyl methyl sulfone, vinyl sulfone, phenyl sulfone, 4-fluorophenyl sulfone, benzyl sulfone, and the like), ethers (such as, triethylene glycol dimethylether (triglyme, G3), tetraethylene glycol dimethylether (tetraglyme, G4), 1,3-dimethyoxy propane, 1,4-dioxane, and the like), phosphates (such as, triethyl phosphate, trimethyl phosphate, and the like), ionic liquids including, for example, ionic liquid cations (such as, 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and the like) and ionic liquid anions (such as, bis(trifluoromethanesulfonyl)imide (TFSI), bis(fluorosulfonyl imide (FS), and the like), and combinations thereof. In certain variations, the solvent includes a first solvent and a second solvent. For example, the first solvent may include ethylene carbonate (EC), and the second solvent may include γ-butyrolactone (GBL). A weight ratio of the first solvent to the second solvent may be about 1:1.

As further detailed below, the sulfolene additive has high reductivity activity, such that a thin (e.g., less than about 50 nm) and substantially uniform solid-state electrolyte interphase (SEI) layer forms on one or more surfaces of the negative electrode 22 (for example, a graphite surface) during formation cycles. For example, in certain variations, the sulfolene additive includes 3-sulfolene (3-SF). In other variations, the sulfolene additive may be represented by one of the following structures:

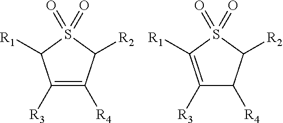

where R₁, R₂, R₃, and R₄ are independently selected from hydrogen (H), linear or branched alkyl groups (e.g., CₙH₂ₙ₊₁, where 1≤n≤20), linear or branched alkene groups (e.g., CₙH₂ₙ, where 1≤n≤20), linear or branched alkoxyl groups (e.g., CₙH₂ₙ₊₁, where 1≤n≤20), linear or branched ether groups (e.g., CₙH₂ₙ₊₁OCₘH₂ₘ, where 1≤n≤10 and 1≤m≤10), phenyl groups, mono-substituted phenyl groups having linear or branched alkyl groups (e.g., CₙH₂ₙ, where 1≤n≤20), di-substituted phenyl groups having linear or branched alkyl groups (e.g., CₙH₂ₙ, where 1≤n≤20), tri-substituted phenyl groups having linear or branched alkyl groups (e.g., CₙH₂ₙ, where 1≤n≤20), nitro groups (NO₂), cyanogen groups (C₂N₂), and halogen groups. In still other variations, the sulfolene additive may have the following structure:

In various aspects, the semi-solid or gel polymer electrolyte 30 may further include another additive. For example, the electrolyte 30 may include greater than or equal to about 0.1 wt. % to less than or equal to about 5 wt. %, and in certain aspects, optionally about 2.5 wt. %, of the another additive. The another additive may include, for example, vinyl ethylene carbonate (VEC), fluoroethylene carbonate (FEC), vinylene carbonate, and/or other derivatives of ethylene carbonate.

The separator 26 may be a microporous polymeric separator having, for example, a porosity greater than or equal to about 5 vol. % to less than or equal to about 100 vol. %. In certain variations, the separator 26 may be a polyolefin-based separator. For example, the polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain variations, the polyolefin may include polyacetylene, polypropylene (PP), polyethylene (PE), or a combination thereof. For example, in the polyolefin-based separator may be a dual-layered separator including, for example, polypropylene-polyethylene. In other instances, the polyolefin-based separator may be a three-layered separator including, for example, polypropylene-polyethylene-polypropylene.

In other variations, the separator 26 may be a cellulose separator including, for example, a polyvinylidene fluoride (PVDF) membrane and/or a polyimide membrane. Further still, in certain instances, the separator 26 ay be a high-temperature stable separator. For example, the separator 26 may be a polyimide nanofiber-based nonwoven separator; a non-sized, alumina (Al₂O₃) and poly(lithium 4-styrenesulfonate)-coated polyethylene membrane; a silica (SiO₂) coated polyethylene separator; a co-polyimide-coated polyethylene separator; a polyetherimides (PEI) (bisphenol-aceton diphthalic anhydride (BPADA) and para-phenylenediamine) separator, an expanded polytetrafluoroethylene reinforced polyvinylidenefluoride-hexafluoropropylene separator, a sandwiched-structure polyvinylidene fluoride (PVDF)-poly(m-phenylene isophthalamide) (PMIA)-polyvinylidene fluoride (PVDF) separator, and the like.

In each variation, the separator 26 may further include a ceramic material and/or a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may include, for example, alumina (Al₂O₃) and/or silica (SiO₂). The heat-resistant material may include, for example, Nomex and/or Aramid.

The positive electrode 24 may be formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles (not shown). Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. In certain variations, the positive electrode 24 may include a plurality of solid-state electrolyte particles (not shown). In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electrode 24 may comprise one or more positive electroactive materials having a spinel structure (e.g., high-power-type spinel materials, such as lithium manganese oxide (Li₍₁₊ₓ₎Mn₂O₄, where 0.1≤x≤1) (LMO) and/or lithium manganese nickel oxide (LiMn₍₂₋ₓ₎NiₓO₄, where 0≤x≤0.5) (LNMO) (e.g., LiMn_{1.5}Ni_{0.5}O₄)); one or more materials with a layered structure (e.g., high power type rock salt layered oxides, such as, lithium cobalt oxide (LiCoO₂)), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co_{0.33}O₂) (NMC), and/or a lithium nickel cobalt metal oxide (LiNi_{(1-x-y)}CoₓM_{y}O₂, where 0<x<0.2, y<0.2, and M may be Al, Mg, Ti, or the like); polyanion materials (such as, LiV₂(PO₄)₃); and/or a lithium iron polyanion oxide with olivine structure (such as, lithium iron phosphate (LiFePO₄) (LFP), lithium manganese-iron phosphate (LiMn₂₋ₓFeₓPO₄, where 0<x<0.3) (LFMP), and/or lithium iron fluorophosphate (Li₂FePO₄F)). In certain variations, the positive electrode 24 may comprise one or more positive electroactive materials selected from the group consisting of: NCM 111, NCM 532, NCM 622, NCM 811, NCMA, LFP, LMO, LFMP, LLC, and combinations thereof.

In certain variations, the positive electroactive material may be optionally intermingled (e.g., slurry cast) with one or more electronically conductive materials that provide an electron conductive path and/or one or more polymeric binder materials that improve the structural integrity of the positive electrode 24. For example, the positive electrode 24 may include greater than or equal to about 30 wt. % to less than or equal to about 98 wt. % of the positive electroactive material, greater than or equal to about 0 wt. % to less than or equal to about 50 wt. % of the electrolyte 30, greater than or equal to 0 wt. % to less than or equal to about 30 wt. % of the electronically conducting material, and greater than or equal to 0 wt. % to less than or equal to about 20 wt. % of the polymeric binder.

Example polymeric binders include polyimide, polyamic acid, polyamide, polysulfone, polyvinylidene difluoride (PVdF), poly(vinylidene fluoride-co-hexafluoropropylene) (PVdF-HFP), polytetrafluoroethylene (PTFE), polytetrafluoroethylene (PTFE), polyacrylic acid, blends of polyvinylidene fluoride and polyhexafluoropropene, poly chlorotrifluoroethylene, ethylene propylene diene monomer (EPDM) rubber, carboxymethyl cellulose (CMC), nitrile butadiene rubber (NBR), styrene-butadiene rubber (SBR), styrene ethylene butylene styrene (SEBS), lithium polyacrylate (LiPAA), sodium polyacrylate (NaPAA), sodium alginate, and/or lithium alginate. Electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 may be formed from a lithium host material that is capable of functioning as a negative terminal of a lithium-ion battery. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, in certain variations, the negative electrode 22 may include a plurality of solid-state electrolyte particles (not shown). In each instance, the negative electrode 22 (including the one or more layers) may have an average thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like). In further variations, the negative electrode 22 may include a silicon-based electroactive material. In still further variations, the negative electrode 22 may include a combination of negative electroactive materials. For example, the negative electrode 22 may include a combination of the silicon-based electroactive material (i.e., first negative electroactive material) and one or more other negative electroactive materials. The one or more other negative electroactive materials may include, for example only, carbonaceous materials (such as, graphite, hard carbon, soft carbon, and the like) and/or metallic active materials (such as tin, aluminum, magnesium, germanium, and alloys thereof, and the like). For example, in certain variations, the negative electrode 22 may include a carbonaceous-silicon based composite including, for example, about or exactly 10 wt. % of a silicon-based electroactive material and about or exactly 90 wt. % graphite.

In certain variations, the negative electroactive material may be optionally intermingled (e.g., slurry cast) with one or more electronically conductive materials that provide an electron conductive path and/or at least one polymeric binder material that improves the structural integrity of the negative electrode 22. For example, the negative electrode 22 may include greater than or equal to about 30 wt. % to less than or equal to about 98 wt. % of the negative electroactive material, greater than or equal to about 0 wt. % to less than or equal to about 50 wt. % of the electrolyte 30, greater than or equal to 0 wt. % to less than or equal to about 30 wt. % of the electronically conducting material, and greater than or equal to 0 wt. % to less than or equal to about 20 wt. % of the polymeric binder.

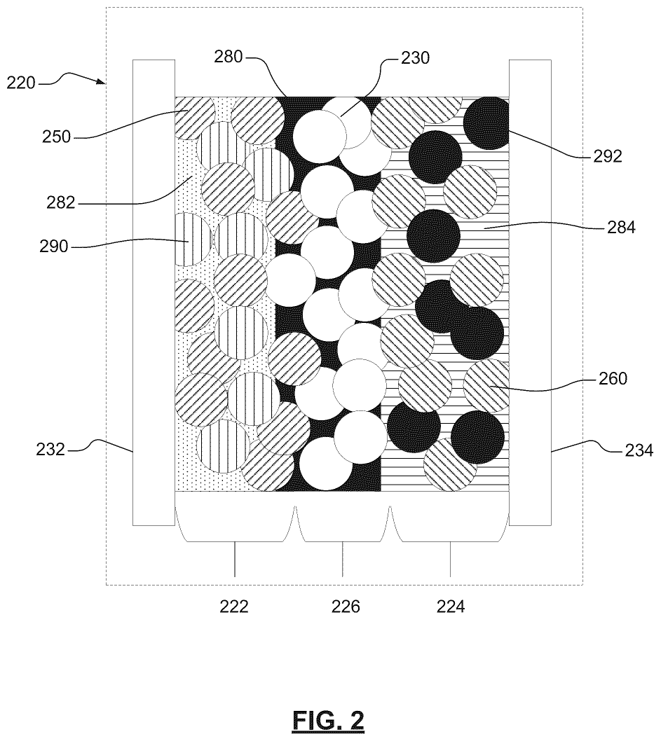

FIG. 2 illustrates another example electrochemical cell (also referred to as a battery) 200. Like the battery 20 illustrated in FIG. 1, the battery 200 may include a negative electrode 222 (e.g., anode), a first current collector 232, a positive electrode 224 (e.g., cathode), and a second current collector 234. In this instance, however, an electrolyte layer 226 occupies a space defined between the two or more electrodes 222, 224. The electrolyte layer 226 is a solid-state or semi-solid state separating layer that physically separates the negative electrode 222 from the positive electrode 224. The electrolyte layer 226 may include a first plurality of solid-state electrolyte particles 230 and a first gel polymer electrolyte 280. In certain variations, as illustrated, a second plurality of solid-state electrolyte particles 290 may be mixed with negative solid-state electroactive particles 250 in the negative electrode 222, and a third plurality of solid-state electrolyte particles 292 may be mixed with positive solid-state electroactive particles 260 in the positive electrode 224. In still further variations, as illustrated, the negative electrode 222 may further include a second gel polymer electrolyte 282, and the positive electrolyte may further include a third gel polymer electrolyte 284.

Like in the battery 20, the second gel polymer electrolyte 282 may be the same as or different form the first gel polymer electrolyte 280, and the third gel polymer electrolyte 284 may be the same as or different from the second gel polymer electrolyte 282. Similarly, the second plurality of solid-state electrolyte particles 290 may be the same as or different from the first plurality of solid-state electrolyte particles 230. The third plurality of solid-state electrolyte particles 292 may be the same as or different form the first plurality of solid-state electrolyte particles 230. For example, in certain variations, the solid-state electrolyte particles 230, 290, 292 may include, for example, oxide-based solid-state particles. The oxide-based solid-state particles may include garnet type solid-state particles (e.g., Li₇La₃Zr₂O₁₂), perovskite type solid-state particles (e.g., Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤x≤2) (LAGP)), and/or LISICON type solid-state particles (e.g., Li₂₊₂ₓZn₁₋ₓGeO₄, where 0<x<1).

In other variations, the solid-state electrolyte particles 230, 290, 292 may include, for example, metal-doped or aliovalent-substituted oxide solid-state particles. The metal-doped or aliovalent-substituted oxide solid-state particles may include aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, and/or aluminum (Al) substituted Li_{1+x+y}AlₓTi₂₋ₓSi_{Y}P_{3-y}O₁₂ (where 0<x<2 and 0<y<3).

In other variations, the solid-state electrolyte particles 230, 290, 292 may include, for example, sulfide-based solid-state particles. The sulfide-based solid-state particles may include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—P₂S₅-MOx systems, Li₂S—P₂S₅-MSx systems, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X (where X is CL, Br, or I), Li_{9.54}Si_{1.74}P_{1.44}S_{11.7}Cl_{0.3}, Li_{9.6}P₃S₁₂, L₁₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}AS_{0.166}S₄, LiI—Li₄SnS₄, and/or Li₄SnS₄.

In other variations, the solid-state electrolyte particles 230, 290, 292 may include, for example, nitride-based solid-state particles. The nitride-based solid-state particles may include Li₃N, Li₇PN₄, and/or LiSi₂N₃.

In other variations, the solid-state electrolyte particles 230, 290, 292 may include, for example, halide-based solid-state particles. The halide-based solid-state particles may include Li₃YCl₆, Li₃InCl₆, Li₃YBr₆, LiI, Li₂CdC₁₄, Li₂MgCl₄, LiCdI₄, Li₂ZnI₄, Li₃OCl, and combinations thereof.

In other variations, the solid-state electrolyte particles 230, 290, 292 may include, for example, hydride-based solid-state particles. The hydride-based solid-state particles may include LiBH₄, LiBH₄—LiX (where x=Cl, Br, or I), LiNH₂, Li₂NH, LiBH₄—LiNH₂, Li₃AlH₆, and combinations thereof.

In other variations, the solid-state electrolyte particles 230, 290, 292 may include, for example, borate-based solid-state particles. The boarate-based solid-state particles may include LI₂B₄O₇ and/or Li₂O—B₂O₃—P₂O₅.

In still further variations, the solid-state electrolyte particles 30 may include a combination of oxide-based solid-state particles, metal-doped or aliovalent-substituted oxide solid-state particles, sulfide-based solid-state particles, nitride-based solid-state particles, halide-based solid-state particles, hydride-based solid-state particles, and/or borate-based solid-state particles.

Certain features of the current technology are further illustrated in the following non-limiting examples.

### Example 1

Example batteries and battery cells may be prepared in accordance with various aspects of the present disclosure.

For example, an example battery cell 310 may have a first gel polymer electrolyte that includes, in addition to a polymer host and a liquid electrolyte, a sulfolene additive, and another additive. The first gel polymer electrolyte may include, for example, about 95 wt. % of the liquid electrolyte and additives and about 5 wt. % of the polymer host. More specifically, the first gel polymer electrolyte may include about 1 wt. % of 3-sulfolene and about 2.5 wt. % of vinyl ethylene carbonate (VEC). The polymer host may include, for example, polyvinylidene fluoride-hexafluoropropylene (PVDF-HFP). The liquid electrolyte may include, for example, about 0.8 M of lithium bis(trifluoromethanesulfonyl)imide (LiTFSI), about 0.8 M of lithium tetrafluoroborate (LiBF₄), and about 0.1 M of lithium bis(oxalato)borate (LiB(C₂O₄)₂) (LiBOB) in a solvent mixture including ethylene carbonate (EC) and γ-butyrolactone (GBL) (4:6 w/w).

A first comparative battery cell 320 may have a second gel polymer electrolyte that includes for example, about 95 wt. % of the liquid electrolyte and additives and about 5 wt. % of the polymer host. More specifically, the second gel polymer electrolyte may include about 2.5 wt. % of vinyl ethylene carbonate (VEC). Like the first gel polymer electrolyte, the polymer host may include, for example, polyvinylidene fluoride-hexafluoropropylene (PVDF-HFP), and the liquid electrolyte may include, for example, about 0.8 M of lithium bis(trifluoromethanesulfonyl)imide (LiTFSI), about 0.8 M of lithium tetrafluoroborate (LiBF₄), and about 0.1 M of lithium bis(oxalato)borate (LiB(C₂O₄)₂) (LiBOB) in a solvent mixture including ethylene carbonate (EC) and γ-butyrolactone (GBL) (4:6 w/w).

A second comparative battery cell 330 may have a third gel polymer electrolyte that includes for example, about 95 wt. % of the liquid electrolyte and about 5 wt. % of the polymer host. That is, the third gel polymer may be free of the sulfolene additive, and also, the another additive. Like the first gel polymer electrolyte and the second gel polymer electrolyte, the polymer host may include, for example, polyvinylidene fluoride-hexafluoropropylene (PVDF-HFP), and the liquid electrolyte may include, for example, about 0.8 M of lithium bis(trifluoromethanesulfonyl)imide (LiTFSI), about 0.8 M of lithium tetrafluoroborate (LiBF₄), and about 0.1 M of lithium bis(oxalato)borate (LiB(C₂O₄)₂) (LiBOB) in a solvent mixture including ethylene carbonate (EC) and γ-butyrolactone (GBL) (4:6 w/w).

The following table compares the compositions of the first, second, and third gel polymer electrolytes.

| | | | Sulfolene | Another |
|---|---|---|---|---|
| Example | Salts | Solvents | Additive | Additive |
| 310 | 0.8M LiTFSI | EC, GBL | 1 wt. % 3-SF | 2.5 wt. % VEC |
| | 0.8M LiBF₄ | 4:6 w/w | | |
| | 0.1M LiBOB | | | |
| 320 | 0.8M LiTFSI | EC, GBL | — | 2.5 wt. % VEC |
| | 0.8M LiBF₄ | 4:6 w/w | | |
| | 0.1M LiBOB | | | |
| 330 | 0.8M LiTFSI | EC, GBL | — | — |
| | 0.8M LiBF₄ | 4:6 w/w | | |
| | 0.1M LiBOB | | | |

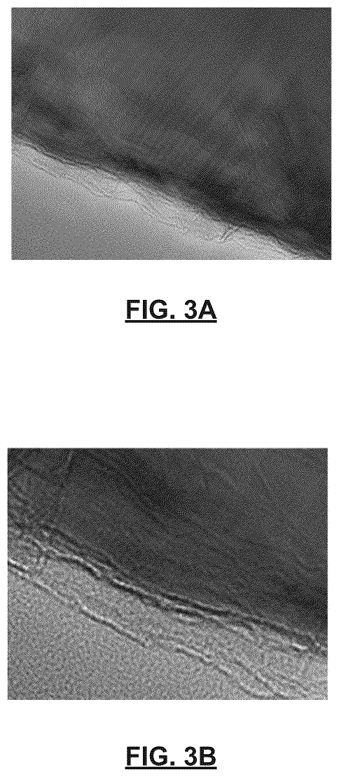

As mentioned above, the gel polymer electrolyte in accordance with various aspects of the present disclosure helps to form a thin and substantially uniform solid-state electrolyte interphase (SEI) layer on one or more surfaces of the negative electrodes (for example, a graphite surface). FIGS. 3A and 3B are microscopic images of an electrode-separator interface for the example cell 310 including the first gel polymer electrolyte, where the scale for FIG. 3A is about 100 nm, and the scale for FIG. 3B is about 50 nm. As illustrated, a solid-state electrolyte interphase (SEI) layer is form. For example, the sulfolene additive promotes decomposition of the lithium salt (e.g., lithium bis(trifluoromethanesulfonyl)imide (LiTFSI)), forming a high lithium-fluoride content solid-state electrolyte interphase (SEI) layer that helps to passivate and stabilize the electrode-electrolyte interface. The solid-state electrolyte interphase (SEI) layer is thin and substantially continuous. For example, the solid-state electrolyte interphase (SEI) layer may have an average thickness greater than or equal to about 10 nm to less than or equal to about 50 nm, and covers greater than or equal to about 95%, optionally greater than or equal to about 96%, optionally greater than or equal to about 97 wt. %, optionally greater than or equal to about 98 wt. %, optionally greater than or equal to about 99%, optionally greater than or equal to about 99.5%, and in certain aspects, optionally greater than or equal to about 99.8%, of a total surface of the electrode.

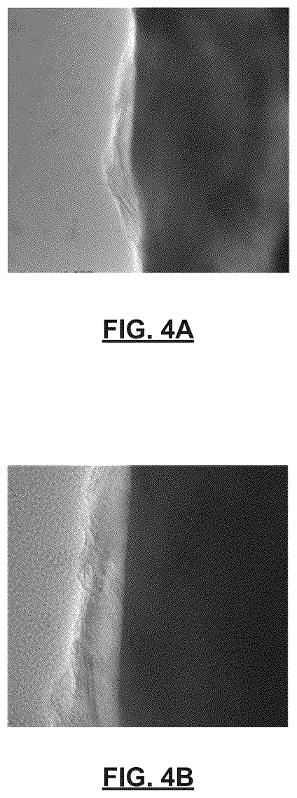

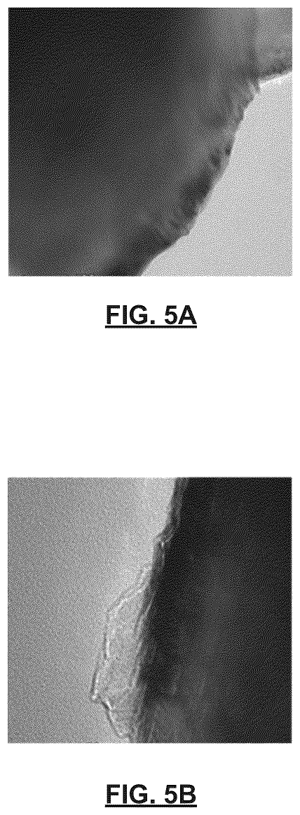

By way of comparison, FIGS. 4A and 4B are microscopic images of an electrode-separator interface for the example cell 320 including the second gel polymer electrolyte, where in scale for FIG. 4A is about 100 nm, and the scale for FIG. 4B is about 50 nm. As illustrated, a solid-state electrolyte interphase (SEI) layer is form. However, in this instance, as illustrated, the solid-state electrolyte interphase (SEI) layer is not continuous and covers only about 90% of a total surface of the electrode. The solid-state electrolyte interphase (SEI) layer in this instances may have an average thickness greater than or equal to about 25 nm to less than or equal to about 50 nm. Further, FIGS. 5A and 5B are microscopic images of an electrode-separator interface for the example cell 330 including the third gel polymer electrolyte, where the scale for FIG. 5A is about 100 nm, and the scale for FIG. 5B is about 50 nm. However, in this instance, as illustrated, only about 10% of a total surface area is covered by a solid-state electrolyte interphase (SEI) layer.

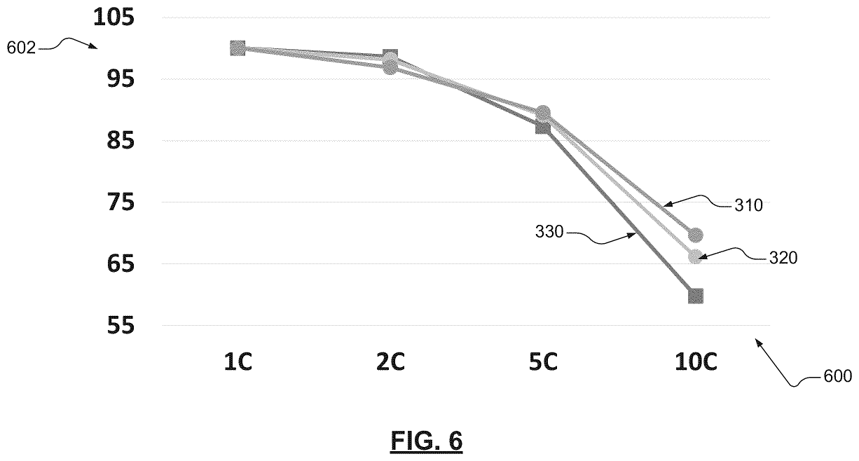

FIG. 6 is a graphical illustration demonstrating the rate capability of the example battery cell 310, as compared to the first comparative battery cell 320 and the second comparative battery cell 330, where the x-axis 600 represents discharge rate, and the γ-axis 602 represents capacity retention (%). As illustrated, the example cell 310 including the first gel polymer electrolyte has improved rate capability, as compared to the first comparative cell 320 including the second gel polymer electrolyte, and also, the second comparative cell 330 including the third gel polymer electrolyte. For example, the example battery cell 310 may have an increased 10C rate capability, for example, about 60% to 70% capacity retention.

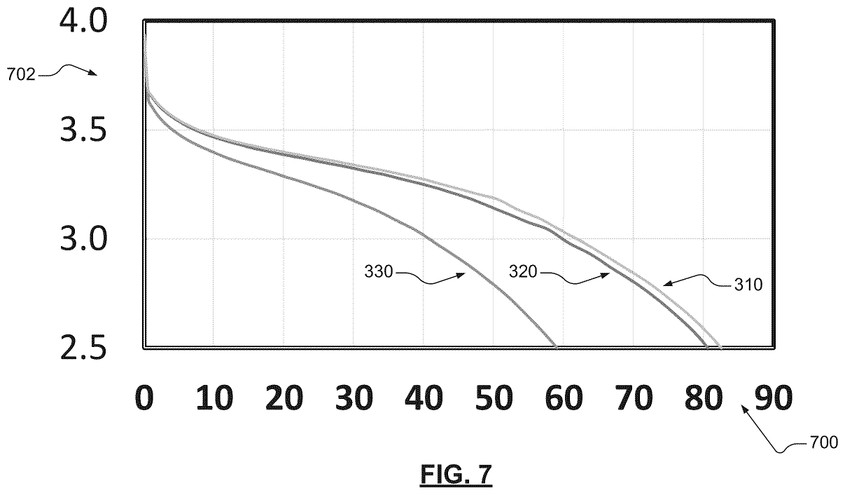

FIG. 7 is a graphical illustration demonstrating the low-temperature discharge performance of the example battery cell 310 as compared to the first comparative battery cell 320 and the second comparative battery cell 330, where the x-axis 700 represents retention (%) and the γ-axis 702 represents voltage (V). As illustrated, the example cell 310 including the first gel polymer electrolyte has improved performance as compared to the first comparative cell 320 including the second gel polymer electrolyte, and also, the second comparative cell 330 including the third gel polymer electrolyte. For example, the example battery cell 310 may have an increased low-temperature capacity delivery of from about 59% to about 82%.

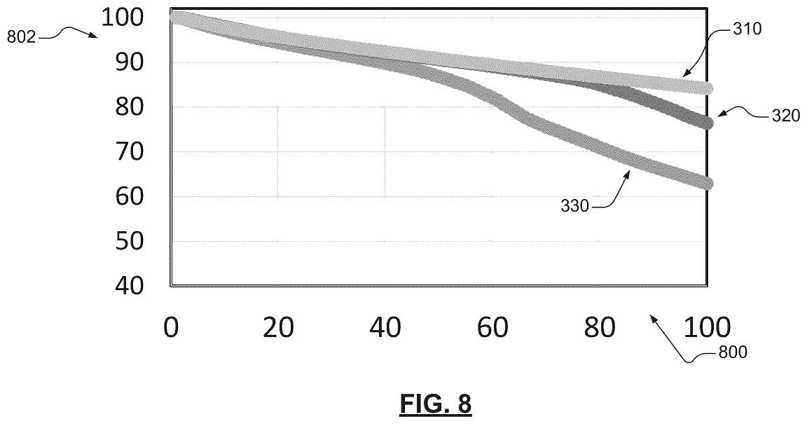

FIG. 8 is a graphical illustration demonstrating high-temperature cycling performance of the example battery cell 310 at 45° C. as compared to the first comparative battery cell 320 and the second comparative battery cell 330, where the x-axis 800 represents cycle number, and the γ-axis 802 represents capacity retention (%). As illustrated, the example cell 310 including the first gel polymer electrolyte has improved performance as compared to the first comparative cell 320 including the second gel polymer electrolyte, and also, the second comparative cell 330 including the third gel polymer electrolyte. For example, the example battery cell 310 may have an increased high-temperature capacity retention from about 63% to about 84%.

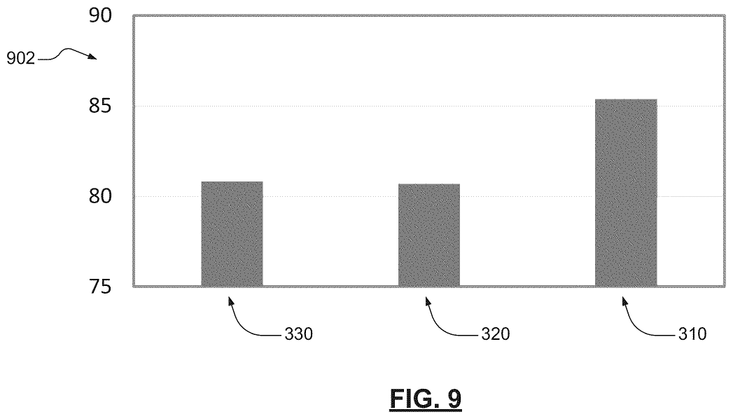

FIG. 9 is a graphical illustration demonstrating the initial cycle Columbic Efficiency of the example battery cell 310 as compared to the first comparative battery cell 320 and the second comparative battery cell 330, where the γ-axis 902 represents initial Columbic Efficiency (%). As illustrated, the example cell 310 including the first gel polymer electrolyte has improved performance as compared to the first comparative cell 320 including the second gel polymer electrolyte, and also, the second comparative cell 330 including the third gel polymer electrolyte. For example, the example cell 310 has a higher Columbic Efficiency (%), which indicates less electrolyte decomposition.

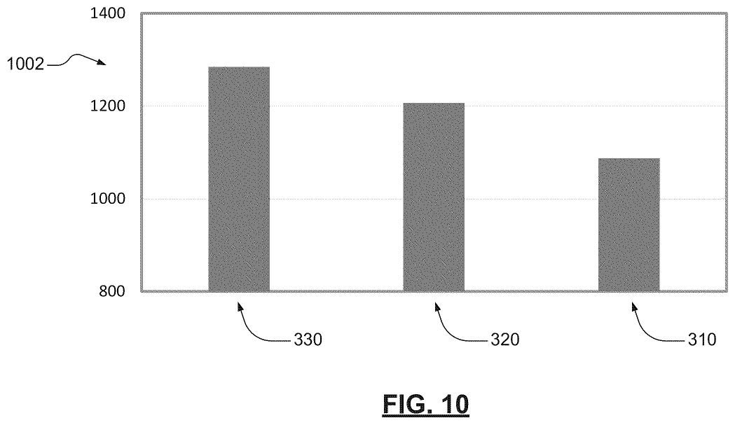

FIG. 10 is a graphical illustration demonstrating the direct current resistance (DCR) of the example battery cell 310 as compared to the first comparative battery cell 320 and the second comparative battery cell 330, where the γ-axis represents DCR/mOhms. As illustrated, the example cell 310 including the first gel polymer electrolyte has improved performance, for example lower cell resistance, as compared to the first comparative cell 320 including the second gel polymer electrolyte, and also, the second comparative cell 330 including the third gel polymer electrolyte.

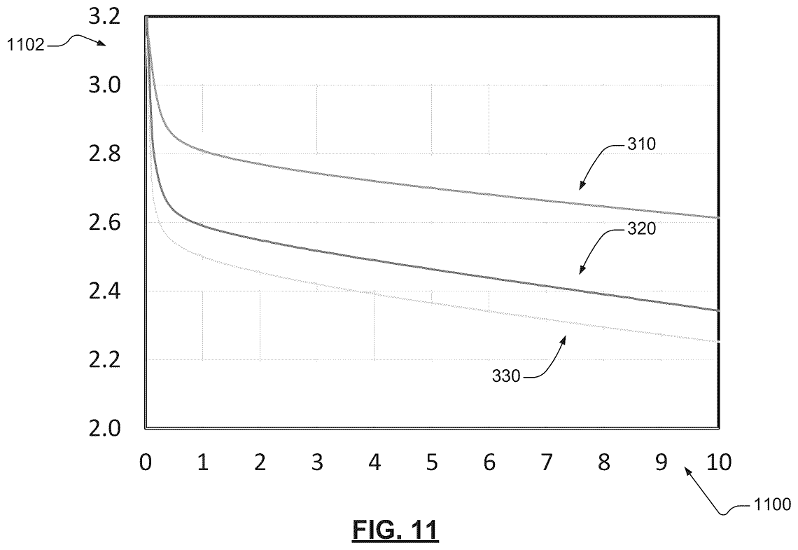

FIG. 11 is a graphical illustration demonstrating the fresh cold-cranking capabilities of the example battery cell 310 as compared to the first comparative battery cell 320 and the second comparative battery cell 330, where the x-axis 1100 represents time (s), and the γ-axis represents voltage (V). As illustrated, the example cell 310 including the first gel polymer electrolyte has improved performance, for example better low temperature cranking performance, as compared to the first comparative cell 320 including the second gel polymer electrolyte, and also, the second comparative cell 330 including the third gel polymer electrolyte.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A gel polymer electrolyte for an electrochemical cell that cycles lithium ions, the gel polymer electrolyte comprising:
a polymer host;
a liquid electrolyte; and
greater than or equal to about 0.1 wt. % to less than or equal to about 10 wt. % of a sulfolene additive.

2. The gel polymer electrolyte of claim 1, wherein the gel polymer electrolyte further comprises:
greater than or equal to about 0.1 wt. % to less than or equal to about 5 wt. % of an ethylene carbonate additive selected from the group consisting of: vinyl ethylene carbonate (VEC), fluoroethylene carbonate (FEC), vinylene carbonate, and combinations thereof.

3. The gel polymer electrolyte of claim 1, wherein the sulfolene additive comprises 3-sulfolene (3-SF) or is represented by one of the following structures: 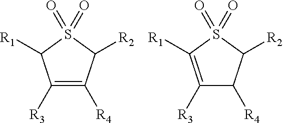
where R₁, R₂, R₃, and R₄ are independently selected from hydrogen, linear or branched alkyl groups, linear or branched alkene groups, linear or branched alkoxyl groups, linear or branched ether groups, phenyl groups, mono-substituted phenyl groups having linear or branched alkyl groups, di-substituted phenyl groups having linear or branched alkyl groups, tri-substituted phenyl groups having linear or branched alkyl groups, nitro groups, cyanogen groups, and halogen groups, or a combination thereof.

4. The gel polymer electrolyte of claim 1, wherein the gel polymer electrolyte comprises:
greater than 0 wt. % to less than or equal to about 40 wt. % of the polymer host, and the polymer host is selected from the group consisting of: poly(acrylic acid) (PAA), polyvinylidene difluoride (PVDF), poly(vinyl alcohol) (PVA), polyethylene oxide (PEO), polyvinylidene fluoride-hexafluoropropylene (PVDF-HFP), polymethyl methacrylate (PMMA), carboxymethyl cellulose (CMC), polyacrylonitrile (PAN), polyvinylpyrrolidone (PVP), and combinations thereof.

5. The gel polymer electrolyte of claim 1, wherein the liquid electrolyte has a lithium salt concentration greater than or equal to about 1.2 M.

6. The gel polymer electrolyte of claim 5, wherein the liquid electrolyte comprises:
a first lithium salt comprising a lithium cation (Li⁺) and an anion selected from the group consisting of: bis(trifluoromethanesulfonyl)imide (TFSI), trifluoromethanesulfonate (triflate), bis(fluorosulfonyl)imide cyclo-difluoromethane-1,1-bis(sulfonyl)imide (DMSI), bis(perfloroethanesulfonyl)imide (BETI), cyclo-hexafluoropropane-1,1-bis(sulfonyl)imide (HPSI), and combinations thereof; and
a second lithium salt comprising a lithium cation (Li⁺) and an anion selected from the group consisting of: tetrafluoroborate, bis(oxalate)boarate (BOB), tetracyanoboarate (bison), difluoro(oxalato)borate (DFOB), bis(fluoromalonato)borate (BFMB), and combinations thereof.

7. The gel polymer electrolyte of claim 6, wherein a concentration of the first lithium salt is greater than or equal to about 0.6 M to less than or equal to about 2.0 M, and a concentration of the second lithium salt is greater than or equal to about 0.6 M to less than or equal to about 2.0 M.

8. The gel polymer electrolyte of claim 6, wherein the liquid electrolyte further comprises:
a third lithium salt distinct from the second lithium salt and comprising a lithium cation (Li⁺) and an anion selected from the group consisting of: bis(oxalate)boarate (BOB), tetrafluoroborate, tetracyanoboarate (bison), difluoro(oxalato)boarate (DFOB), bis(floromalonato)borate (BFMB), and combinations thereof.

9. The gel polymer electrolyte of claim 8, wherein a concentration of the third lithium salt is greater than or equal to about 0.05 M to less than or equal to about 1.0 M.

10. A semi-solid state electrochemical cell comprising:
a first electrode comprising a positive electroactive material;
a second electrode comprising a negative electroactive material; and
a separating layer physically separating the first electrode and the negative electrode, the separating layer comprising a gel polymer electrolyte that comprises:
a polymer host;
a liquid electrolyte;
greater than or equal to about 0.1 wt. % to less than or equal to about 10 wt. % of a sulfolene additive; and
greater than or equal to about 0.1 wt. % to less than or equal to about 5 wt. % of an ethylene carbonate additive selected from the group consisting of: vinyl ethylene carbonate (VEC), fluoroethylene carbonate (FEC), vinylene carbonate, and combinations thereof.

11. The semi-solid state electrochemical cell of claim 10, further comprising:
a solid-state electrolyte interphase (SEI) layer having an average thickness greater than or equal to about 10 nm to less than or equal to about 50 nm at an interface between the second electrode and the separating layer, the solid-state electrolyte interphase (SEI) layer covering greater than or equal to about 95% of a surface of the second electrode.

12. The semi-solid state electrochemical cell of claim 10, wherein the sulfolene additive comprises 3-sulfolene (3-SF) or is represented by one of the following structures: 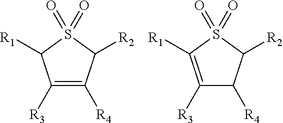
where R₁, R₂, R₃, and R₄ are independently selected from hydrogen, linear or branched alkyl groups, linear or branched alkene groups, linear or branched alkoxyl groups, linear or branched ether groups, phenyl groups, mono-substituted phenyl groups having linear or branched alkyl groups, di-substituted phenyl groups having linear or branched alkyl groups, tri-substituted phenyl groups having linear or branched alkyl groups, nitro groups, cyanogen groups, and halogen groups, or a combination thereof.

13. The semi-solid state electrochemical cell of claim 10, wherein the liquid electrolyte comprises:
a first lithium salt comprising a lithium cation (Li⁺) and an anion selected from the group consisting of: bis(trifluoromethanesulfonyl)imide (TFSI), trifluoromethanesulfonate (triflate), bis(fluorosulfonyl)imide cyclo-difluoromethane-1,1-bis(sulfonyl)imide (DMSI), bis(perfloroethanesulfonyl)imide (BETI), cyclo-hexafluoropropane-1,1-bis(sulfonyl)imide (HPSI), and combinations thereof;
a second lithium salt comprising a lithium cation (Li⁺) and an anion selected from the group consisting of: tetrafluoroborate, bis(oxalate)boarate (BOB), tetracyanoboarate (bison), difluoro(oxalato)borate (DFOB), bis(fluoromalonato)borate (BFMB), and combinations thereof; and
a third lithium salt that is distinct from the second lithium salt and comprises a lithium cation (Li⁺) and an anion selected from the group consisting of: bis(oxalate)boarate (BOB), tetrafluoroborate, tetracyanoboarate (bison), difluoro(oxalato)boarate (DFOB), bis(floromalonato)borate (BFMB), and combinations thereof.

14. The semi-solid state electrochemical cell of claim 13, wherein a concentration of the first lithium salt is greater than or equal to about 0.6 M to less than or equal to about 2.0 M, a concentration of the second lithium salt is greater than or equal to about 0.6 M to less than or equal to about 2.0 M, and a concentration of the third lithium salt is greater than or equal to about 0.05 M to less than or equal to about 1.0 M.

15. The semi-solid state electrochemical cell of claim 10, wherein the gel polymer electrolyte is a first gel polymer electrolyte, the first electrode further comprises a second gel polymer electrolyte, and the second electrode further comprises a third gel polymer electrolyte.

16. The semi-solid state electrochemical cell of claim 15, wherein the first electrode further comprises a first plurality of solid-state electrolyte particles, and the second electrode further comprises a second plurality of solid-state electrolyte particles.

17. The semi-solid state electrochemical cell of claim 10, wherein the separating layer further comprises a plurality of solid-state electrolyte particles.

18. The semi-solid state electrochemical cell of claim 10, wherein the separating layer further comprises a microporous polymeric separator having a porosity greater than or equal to about 5 vol. % to less than or equal to about 100 vol. %.

19. A gel polymer electrolyte for an electrochemical cell that cycles lithium ions, the gel polymer electrolyte comprising:
greater than or equal to about 1 wt. % to less than or equal to about 40 wt. % of a polymer host;
a liquid electrolyte comprising:
a first lithium salt comprising a lithium cation (Li⁺) and an anion selected from the group consisting of: bis(trifluoromethanesulfonyl)imide (TFSI), trifluoromethanesulfonate (triflate), bis(fluorosulfonyl)imide cyclo-difluoromethane-1,1-bis(sulfonyl)imide (DMSI), bis(perfloroethanesulfonyl)imide (BETI), cyclo-hexafluoropropane-1,1-bis(sulfonyl)imide (HPSI), and combinations thereof;
a second lithium salt comprising a lithium cation (Li⁺) and an anion selected from the group consisting of: tetrafluoroborate, bis(oxalate)boarate (BOB), tetracyanoboarate (bison), difluoro(oxalato)borate (DFOB), bis(fluoromalonato)borate (BFMB), and combinations thereof; and
a third lithium salt that is distinct from the second lithium salt and comprises a lithium cation (Li⁺) and an anion selected from the group consisting of: bis(oxalate)boarate (BOB), tetrafluoroborate, tetracyanoboarate (bison), difluoro(oxalato)boarate (DFOB), bis(floromalonato)borate (BFMB), and combinations thereof;
greater than or equal to about 0.1 wt. % to less than or equal to about 10 wt. % of a sulfolene additive; and
greater than or equal to about 0.1 wt. % to less than or equal to about 5 wt. % of an ethylene carbonate additive selected from the group consisting of: vinyl ethylene carbonate (VEC), fluoroethylene carbonate (FEC), vinylene carbonate, and combinations thereof.

20. The gel polymer electrolyte of claim 19, wherein the sulfolene additive comprises 3-sulfolene (3-SF) or is represented by one of the following structures: 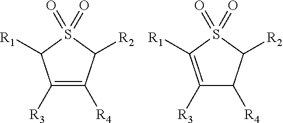
where R₁, R₂, R₃, and R₄ are independently selected from linear or branched alkyl groups, linear or branched alkene groups, linear or branched alkoxyl groups, linear or branched ether groups, phenyl groups, mono-substituted phenyl groups having linear or branched alkyl groups, di-substituted phenyl groups having linear or branched alkyl groups, tri-substituted phenyl groups having linear or branched alkyl groups, nitro groups, cyanogen groups, and halogen groups, or a combination thereof.
